(19) United States
(12) Patent Application Publication
(10) Pub. No.: US 2009/0255966 A1
(43) Pub. Date: Oct. 15, 2009

(54) Device for adjustably holding a rack on a pickup truck

(76) Inventor: Vuthisit Prapavat, Downey, CA (US)

Correspondence Address: MILDE & HOFFBERG, LLP, 10 BANK STREET, SUITE 460, WHITE PLAINS, NY, 10606, US

(21) Appl. No.: 12/322,654

(22) Filed: Feb. 5, 2009

Related U.S. Application Data
(60) Provisional application No. 61/123,847, filed on Apr. 11, 2008.

(51) Int. Cl. B60R 9/045; B60R 9/00

(52) U.S. Cl. 224/403

(57) ABSTRACT

A device for adjustably holding a rack in the bed of a pickup truck where the rack is of the type having a vertical support and that is inserted into a base attached to the floor of the pickup truck bed. The adjustable device comprises a first metal plate, adapted to be fixed to the upper flat surface of the pickup truck side, and a second metal plate, having a groove in one side, that is slidably connected to the first plate using one or more bolts. The second metal plate has a vertical sleeve through which the vertical support of the rack is placed prior to connecting to the base plate. The position of the second plate is adjustable either in the direction of travel or perpendicular to the direction of travel of the vehicle, by selecting the angular position of the sleeve about its axis, thereby adjusting the position of the rack in either of the two directions.

### CROSS-REFERENCE TO RELATED APPLICATIONS

This application claims priority from U.S. provisional application No. 61/123,847 filed Apr. 11, 2008.

### BACKGROUND OF THE INVENTION

The present invention relates to a device for holding and adjusting a rack within the bed of a pickup truck or other similar type vehicle.

It has long since been the practice of workmen or drivers of pickup trucks to utilize their trucks for transporting materials and equipment that are too long to fit into the bed of the truck. Such materials and equipment could include lengths of wood or pipe, and ladders or similar devices. Typically, the operator would employ a rack for transporting the oversized material or equipment, the rack being attached to the outside of the truck or within the bed of the pickup truck. However, for such racks that are located within the bed of the truck there are problems in properly positioning and adjusting the rack, and also for safely securing the rack at the same time. There are also problems in re-positioning the rack for transporting different materials, particularly when the rack is solidly attached within the bed of the pickup truck.

Accordingly, there arises a need for a mechanism and device that supports a rack for carrying equipment, such as a ladder, and at the same time allows for the position of the rack to be adjusted for a different use. The device needs to be simple and easy to operate, and allow for adjustability in more than one direction.

### OBJECTS OF THE INVENTION

It is therefore a principal object of the invention to provide an adjustable device for transporting oversized materials and equipment by a pickup truck or similar vehicle.

It is also an object of the invention to provide a device for securely supporting a rack within the bed of a pickup truck or similar vehicle.

It is a further object of the invention to provide a device for adjusting the position of a carrying rack located within the bed of a pickup truck or similar vehicle.

It is another object of the invention to provide a device that can interchangeably adjust the position of a carrying rack located within the bed of a pickup truck or similar vehicle in more than one direction.

These and other objects of the invention will become more apparent in the description below.

### SUMMARY OF THE INVENTION

A principal object of the present invention is to provide a device for supporting and adjusting the position of a rack that is attached to the inside of the bed of a pickup truck, the rack being designed to carry materials and items such as pipes and ladders of a workman. Moreover, it is a principal object of this invention to provide a device for adjusting a rack in more than one direction, such that the direction of adjustment can be selected by the operator.

In accordance with the invention, a device for adjustably holding a rack in the bed of a pickup truck comprises a vertical support member that is inserted into a base attached to the floor of the pickup truck bed. The adjustable device further comprises a first metal plate fixed to the upper flat surface of the pickup truck side and a second metal plate, having a groove within one side. The second plate is slidably connected to the first plate using one or more bolts. The second metal plate further comprises a vertical sleeve through which the vertical support of the rack is placed prior to connecting to the base plate. The position of the second plate is adjustable either in the direction of travel or perpendicular to the direction of travel of the vehicle, by selecting the angular position of the sleeve about its axis, thereby adjusting the position of the rack in either of the two directions.

A rack for carrying an item, such as a ladder, is located at the upper end of the vertical support. In a preferred embodiment, the rack comprises a frame that is adjustable to the width of the ladder, for transporting the ladder horizontally, and that can be pivotally adjusted based on a desired angle for carrying the ladder.

Thus, the present invention provides a device for holding and adjustably positioning a rack attached within the bed of a pickup truck in two alternative directions allowing for flexibility and ease of operation in selecting the position for the rack.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a side view of a rack mounted in the bed of a pickup truck in accordance with a preferred embodiment of the present invention.

FIG. 2 is a view of a plate member in accordance with the preferred embodiment of the present invention.

FIG. 3 is a view of a plate and sleeve in the preferred embodiment of the present invention.

FIG. 4 is a perspective view of the assembled preferred embodiment of the present invention.

FIG. 5 is a perspective view of the preferred embodiment of the present invention, illustrating adjustment in the direction of travel of the vehicle.

FIG. 6 is a perspective view of the preferred embodiment of the present invention, illustrating an extended adjustment in the direction of travel of the vehicle.

FIG. 7 is a perspective view of the preferred embodiment of the present invention, illustrating adjustment perpendicular to the direction of travel of the vehicle.

### DETAILED DESCRIPTION OF THE PREFERRED EMBODIMENTS

The invention was previously described in provisional application Ser. No. 61/123,847, filed Apr. 11, 2008. The disclosure thereof is hereby incorporated by reference.

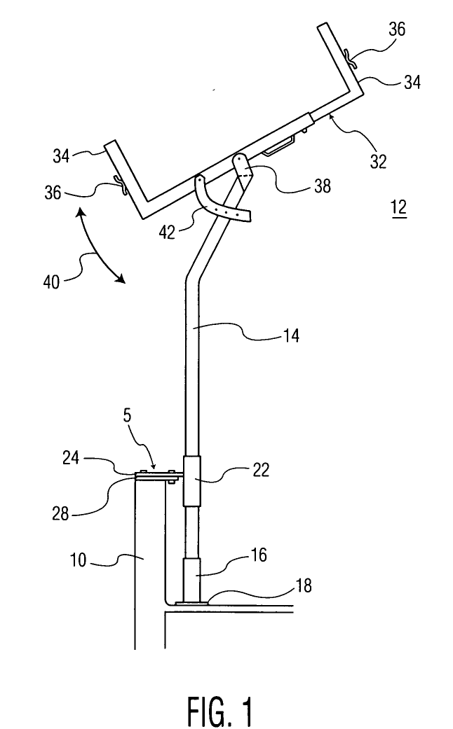

The preferred embodiments of the present invention will now be described with reference to FIGS. 1-7 of the drawings. Identical elements in the various figures are designated with the same reference numerals. The various embodiments of the invention described below are preferably made from steel or other substantially strong metal or material.

FIG. 1 shows an adjustable support 5 for holding a rack inside the bed of a pickup truck, having features which make it particularly suited for users of pickup trucks to transport items such as pipes, ladders or building materials is described. It will be understood how other racks having vertical members and adjustable supports may embody the principles and features of this invention.

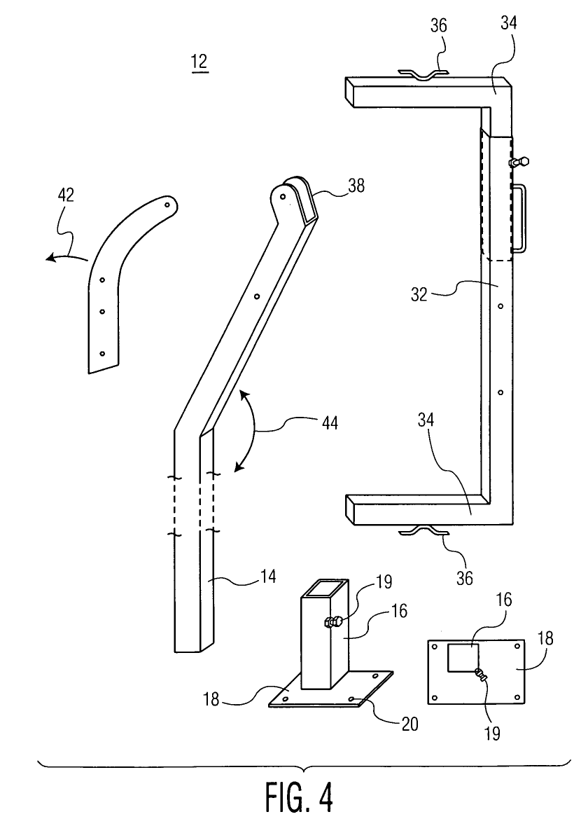

FIGS. 1-4 illustrate the preferred embodiment of a rack according to the invention, generally designated by the reference number 12. FIG. 1 provides a view of the pickup truck body 10 supporting a rack 12. Rack 12 is comprised of various parts which are collectively shown in FIG. 4. Rack 12 includes a vertical support 14 formed of one and a half inch square steel. Vertical support 14 can be in any shape, with round or square tubular shapes being preferred. The lower end of the vertical support 14 fits into an upstanding square receptacle 16 welded to a flat horizontal base 18. Receptacle 16 includes a set screw 19 (such as an Alan screw) that can be tightened against vertical support 14 to hold it in place. Other means of securing vertical support 14 within receptacle 18 may be used, as known to persons of ordinary skill in this art. The base 18, in this embodiment, contains four holes 20, one in each corner, by which base 18 can be bolted to the floor of the bed of the pickup truck.

Also shown in FIGS. 1 and 4 is one embodiment of a rack 12 that has utility in mounting within the bed of a pickup truck, such as for carrying ladders. In this embodiment, rack 12 comprises a frame 32 having arms 34 spaced apart and adjustable based, for example, on the width of a ladder. On the outside of the arms 34 are positioned means 36 for tying a rope or cord to secure the ladder. Frame 32 can be mounted in its center to the upper end of vertical support 14 by means of opposed flanges 38. In this manner, frame 32 can be pivoted about its center, as denoted by arc 40, FIG. 1. A stopping mechanism 42 can be attached at one end to frame 32, and is adjustably connectable to vertical support 14 to secure frame 32 at a desired angle.

Supporting member 14 is also passed through, and supported by, a hollow sleeve 22 which is in the same shape as vertical support 14 shown in FIGS. 1-4 as being square. Sleeve 22 is adjustably mounted to the side of the pickup truck as follows. Sleeve 22 is attached to plate 24, the preferred means of attachment being welding, oriented in a perpendicular position with respect to the plane of plate 24. In this manner, when plate 24 is placed in a horizontal, flat position, sleeve 22 becomes vertical. See FIGS. 1 and 3. In one embodiment, plate 24 provides a perpendicular flange 25, against which sleeve 22 is placed before welding. Flange 25 thereby provides support and strength to the connection of sleeve 22 to plate 24. Plate 24 can be of a variety of shapes, but the preferred from is an angular shape such as an “L” shape. In this embodiment, plate 24 has a long member 27 and a shorter member 29. Plate 24 further provides a groove 26 located along the length of the center of member 27. Groove 26 allows for adjustment of the plate 24/sleeve 22 assembly as further described below.

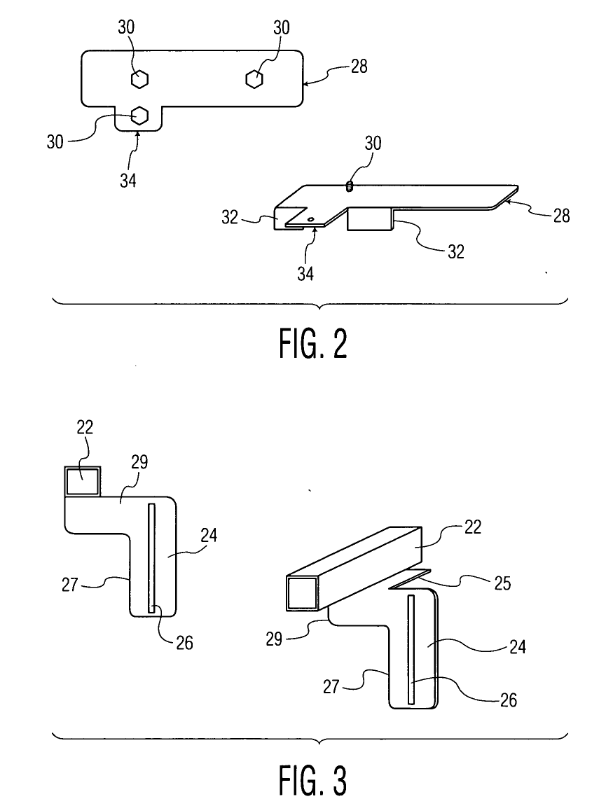

Plate 24 adjustably rests upon a further support plate 28, which itself is horizontally attached to the upper surface of the side of the pickup truck bed. See FIGS. 1 and 5-7. The attachment can be by any conventional attachment method, such as welding or simply using bolts. Support plate 28 is generally rectangular in shape, having a width approximately the same as the width of the side of the pickup truck bed to which it is attached. In addition, support plate 28 may have one or more perpendicular flanges 32 which are configured to contact the inside of the side of the pickup truck bed and therefore provide further support to the attachment of support plate 28. In one embodiment, support plate 28 comprises and extended portion 34 (FIG. 2), to provide additional surface area and support for resting plate 24. Support plate 28 further provides means for adjustably connecting plate 24. In a preferred embodiment, one or more bolts 30 are used for this purpose. In connecting plate 24 with plate 28, plate 24 is laid flat on top of plate 28, and bolts 30 are passed through slot 26 and screwed into plate 28. When more than one bolt 30 is used, the bolts 30 may be aligned along the length of plate 28 (FIGS. 2 & 7), or aligned perpendicular to the length of plate 28 (FIGS. 2 and 5-6), in which case on of the bolts 30 can be located on extension 34.

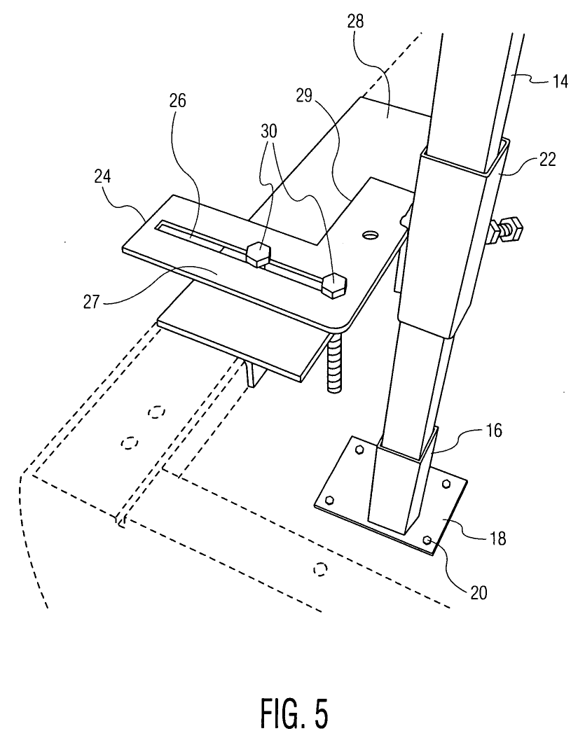

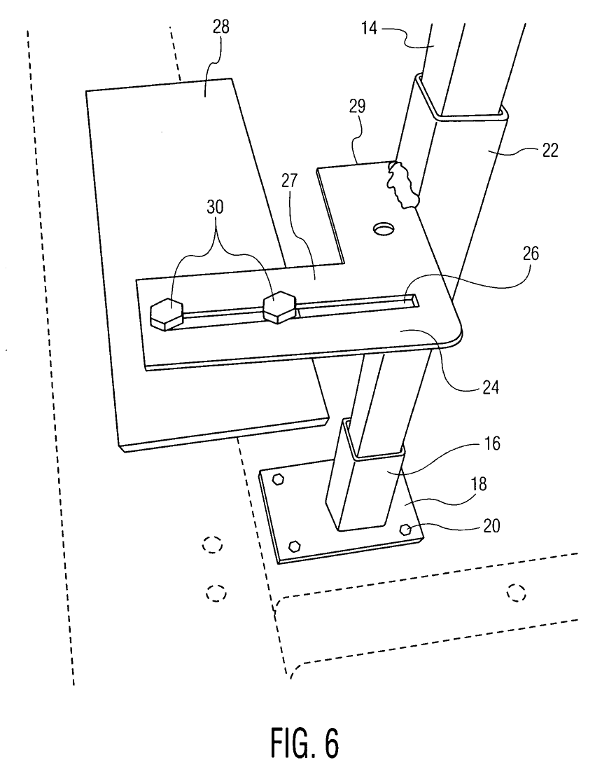

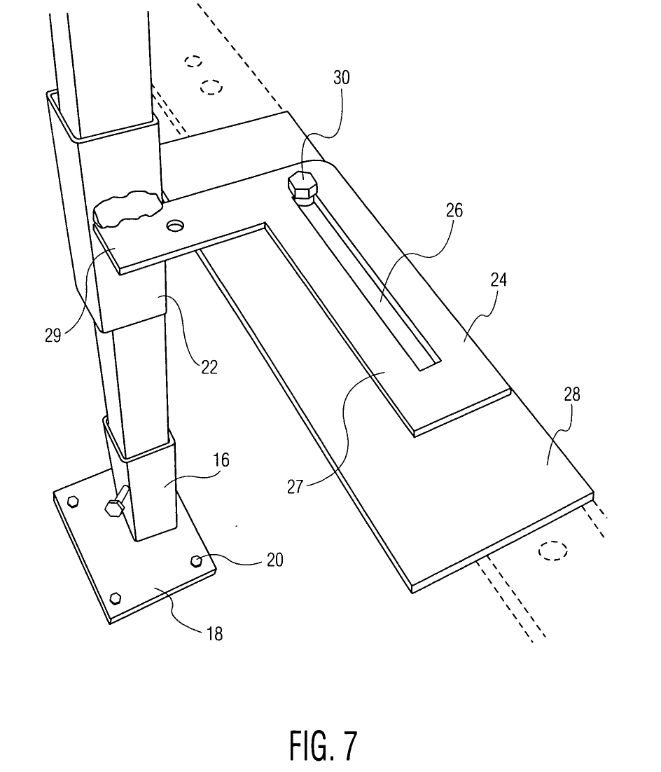

FIGS. 3 and 5-7 illustrate the adjustable mounting of plate 24/sleeve 22 assembly on plate 28. The plates 24 and 28 are held securely by tightening bolts 30. To position the rack 12, the bolts 30 are loosened to the extent that plate 24 can now be moved to a degree allowable by the length of groove 26 in plate 24. Depending upon the alignment of the bolts 30 in plate 28, the position of plate 24 is adjustable in either of two directions. Specifically, plate 24 can be adjusted from a retracted position in the direction of travel of the vehicle (FIG. 5), to an extended position in that same direction (FIG. 6). Alternatively, plate 24 can be adjusted from side to side in a direction perpendicular to the direction of travel of the vehicle (FIG. 7). This two-fold adjustment is derived by mounting plate 24 along length 27 either parallel or perpendicular to plate 28. Inconsequentially, this also affects the angular position of sleeve 22 about its axis.

In actual adjustable assembly of a rack 12 in the bed of a pickup truck, the position of the rack 12 is selected by adjusting plate 24 with respect to plate 28. Once that position is selected, base 18 can be attached to the floor of the bed of the pickup truck once aligned with vertical member 14 passing through sleeve 22.

As can be appreciated by those having skill in this art, more than one adjustable rack according to this invention may be used in a the bed of a pickup truck, depending on the material or item to be transported. For example, at least two of the adjustable racks of this invention may be needed to transport ladders, pipes or lengths of wood.

The preferred embodiment described above is illustrative of the practice of the invention. It is to be understood, however, that other expedients known to those of skill in the art, or disclosed herein, may be employed without departing from the spirit of the invention or the scope of the claims.

What is claimed is:

1. A device for adjustably holding a rack in the bed of a pickup truck, wherein said rack comprises a vertical support member and a bottom support base for receiving the vertical support member, said device comprising:
a first plate member adapted to be horizontally mounted on an upper surface of a side of the pickup truck bed;
a sleeve member through which the vertical support member of the rack can be slidably inserted; and
a second horizontal plate member connected to said sleeve member, said second horizontal plate member comprising an adjustment slot along a length of the second horizontal plate;
wherein, the second horizontal plate member is movably mounted to the first plate member by adjustable connecting means passing through the adjustment slot of the second horizontal plate member and attached to the first plate member;
whereby the position of the second horizontal plate member may be slidably adjusted relative to the first plate member means of the adjustment slot and connecting means.

2. The device of claim 1, wherein said second horizontal plate member is configured in an “L” shape having a longer length on one side and a shorter length on the other side.

3. The device of claim 2, wherein the adjustment slot is provided in the longer length side of the second horizontal plate member.

4. The device of claim 1, wherein the second horizontal plate member is mounted to the first plate member such that the position of the second horizontal plate member is adjustable in the direction of travel of the pickup truck.

5. The device of claim 1, wherein the second horizontal plate member is mounted to the first plate member such that the position of the second horizontal plate member is adjustable perpendicular to the direction travel of the pickup truck.

6. The device of claim 1, wherein the second horizontal plate member further comprises a flange perpendicular to the plate for attaching the sleeve member.

7. The device of claim 1, wherein the first plate member further comprises one or more flanges perpendicular to the first plate for providing support against the side of the pickup truck bed.

8. The device of claim 1, wherein the adjustable connecting means further comprises one or more machine bolts passing through the adjustment slot and into the first plate member.

9. An adjustable rack in the bed of a pickup truck, wherein said rack comprises a vertical support member and a bottom support base for receiving the vertical support member, said rack comprising:
a vertical support member;
a support base adapted to be mounted on the floor of the pickup truck bed for receiving the bottom end of the vertical support member;
a holding portion at the upper end of the vertical support member;
a first plate member adapted to be horizontally mounted on an upper surface of a side of the pickup truck bed;
a sleeve member through which the vertical support member of the rack can be slidably inserted, said sleeve member connected to a second horizontal plate member adjustable mounted on said first plate member;
said second horizontal plate member comprising an adjustment slot along a length of the second horizontal plate;
wherein, the second horizontal plate member is movably mounted to the first plate member by adjustable connecting means passing through the adjustment slot of the second horizontal plate member and attached to the first plate member;
whereby the position of the second horizontal plate member may be slidably adjusted relative to the first plate member means of the adjustment slot and connecting means.

10. The device of claim 9, wherein said second horizontal plate member is configured in an “L” shape having a longer length on one side and a shorter length on the other side.

11. The device of claim 10, wherein the adjustment slot is provided in the longer length side of the second horizontal plate member.

12. The device of claim 9, wherein the second horizontal plate member is mounted to the first plate member such that the position of the second horizontal plate member is adjustable in the direction of travel of the pickup truck.

13. The device of claim 9, wherein the second horizontal plate member is mounted to the first plate member such that the position of the second horizontal plate member is adjustable perpendicular to the direction travel of the pickup truck.

14. The device of claim 9, wherein the second horizontal plate member further comprises a flange perpendicular to the plate for attaching the sleeve member.

15. The device of claim 9, wherein the first plate member further comprises one or more flanges perpendicular to the first plate for providing support against the side of the pickup truck bed.

16. The device of claim 9, wherein the adjustable connecting means further comprises one or more machine bolts passing through the adjustment slot and into the first plate member.
